(19) United States
(12) Patent Application Publication
(10) Pub. No.: US 2012/0186684 A1
(43) Pub. Date: Jul. 26, 2012

(54) Flame Resistant Hose Construction and Method

(75) Inventors: Kenneth Martin Giovannetti, Denver, CO (US); James Halfmann, Centennial, CO (US); Joe Carmon Haney, Littleton, CO (US); Matthew James King, Parker, CO (US); Lance D. Miller, Highlands Ranch, CO (US); Jonathan Clark Swift, Denver, CO (US); Rodger Leo Thummel, Iola, KS (US)

(73) Assignee: THE GATES CORPORATION, Denver, CO (US)

(21) Appl. No.: 13/012,378

(22) Filed: Jan. 24, 2011

(51) Int. Cl. F16L 11/12; B29C 63/10

(52) U.S. Cl. 138/137; 156/188

(57) ABSTRACT

A multi-layer flexible hose with at least one vulcanized elastomer layer and an outermost cover layer of a thermoplastic polyurethane strip that is wrapped and thermally fused to form a continuous layer. The wrapping may be helical or longitudinal. The polyurethane includes a high hardness, a softening point at or below the vulcanization temperature, and an intumescent flame retarding additive stable at the vulcanization temperature. The polyurethane cover adheres to the elastomer layer and contributes to the flame resistance required by API 16D or of Lloyd's Register Fire Tests for Flexible Hoses on Offshore Installations OD/1000/499 rev. 1.

### BACKGROUND OF THE INVENTION

1. Field of the Invention

This invention relates generally to a flame resistant hydraulic hose construction, more particularly to a multi-layer hose with a helically wrapped outer layer of flame resistant thermoplastic polyurethane, and to a method of making the same.

2. Description of the Prior Art

Flexible hose used for off-shore and land based oil derricks may be required to be tested for its ability to meet relevant fire integrity requirements. For example, kill, choke and jumper hoses and hydraulic control hoses serving well complete units and blow out preventers may be required to pass an aggressive fire test called OD/1000/499 rev. 1, “Lloyd's Register Fire Tests for Flexible Hoses on Offshore Installations,” 2nd edition. Another such specification for Blow-Out Preventer hoses is API 16D. In order to meet such flame resistance requirements, existing hydraulic hoses have been equipped with ceramic fiber insulation and a stainless steel sheath, an approach requiring extra process steps, extra time and labor, and relatively expensive materials. The presence of the steel outer sheath with the fire resistant sleeve underneath also makes coupling installation difficult and costly.

Another approach has been to extrude a layer of flame resistant material such as a fire retardant polyurethane over the outside of a hydraulic hose, which involves relatively expensive extrusion equipment and additional process steps.

### SUMMARY

The present invention is directed to systems and methods which provide a flame resistant hose that can be made economically and efficiently.

The invention is directed to a high pressure hydraulic hose having a cover layer of fire retardant polyurethane wrapped onto it in order to impart the flame resistance needed for the oilfield applications such as API 16D. The hose has a vulcanized elastomer layer to which the wrapped polyurethane film is bonded. The helical or longitudinal seams of the wrapped polyurethane film are fused together to form a continuous layer. The hose has the distinctive marks of the fabric wrap used in the vulcanization process. Preferably the polyurethane is a polyether polyurethane with at least one fire retardant additive, preferably an intumescent fire retardant composition. The elastomer layer may be a polychloroprene composition. The polyurethane may be an aromatic polyether polyurethane. The polyurethane cover may be the outermost cover layer of the hose. The elastomer layer may be vulcanized and fused before applying the wrapped polyurethane cover layer.

The invention is also directed to a hose assembly or system having an embodiment of the inventive hose and one or more couplings. The coupling may be of the hydraulically crimped type. The coupling may be applied to an end portion of the hose where the outer polyurethane layer has been removed. The coupling area may include some fire resistant sleeve, insulating tape, or the like, for example to compensate for the removed polyurethane. The hose may also have one or more reinforcing layer such as spiraled steel wire, woven or braided or wrapped textiles or wire, or the like.

The invention is also directed to a method of making a flame resistant hose including the steps of forming one or more inner layers including at least one vulcanizable rubber layer, applying as an outer cover layer a helically wrapped strip of fire retardant polyurethane to form a hose build, applying a fabric wrap and curing the wrapped hose build at a suitable temperature and for a suitable time period. Curing this way vulcanizes the rubber layer, fuses the helically wrapped polyurethane to itself, and bonds the polyurethane to the rubber layer. The fabric wrap, which may be nylon wrap, may then be easily removed. In another embodiment, the inner layers may be vulcanized before applying the outer cover layer.

Embodiments of the inventive hose pass a fire test involving five minutes at a temperature between 700 and 750° C. under the design maximum working pressure of the hose according to the procedure of Lloyd's Fire Test OD/1000/499 and the American Petroleum Institute, API 16D.

Embodiments of the inventive method provide reduced process steps over the prior art, in particular the polyurethane wrapped layer may be applied to an uncured hose build and the entire assembly cured in one cure operation. The polyurethane preferably has a softening temperature or a melting temperature that is below or in the region of the desired cure temperature. The polyurethane preferably has fire retardant additives that do not react at the desired cure temperature. The polyurethane is preferably non-foaming at the desired cure temperature. It is also advantageous for the use of steam cure that the polyurethane is non-foaming in steam at the desired cure temperature.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

The accompanying drawings, which are incorporated in and form part of the specification in which like numerals designate like parts, illustrate embodiments of the present invention and together with the description, serve to explain the principles of the invention. In the drawings:

FIG. 1 is a partially fragmented view of a hose embodiment of the invention;

FIG. 2 is a partially fragmented view showing aspects of a method embodiment of the invention;

FIG. 3 is a partially fragmented, cross-sectional illustration of an assembly according to an embodiment of the invention; and

FIG. 4 is a partially fragmented view showing aspects of another embodiment of the invention.

### DETAILED DESCRIPTION

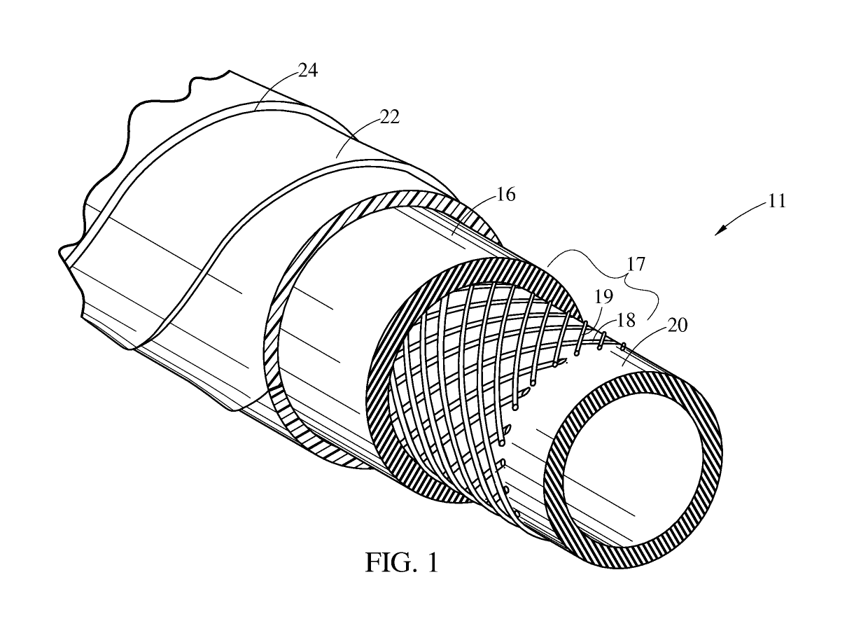

The present invention is directed to systems and methods which provide a flame resistant hose that can be made economically and efficiently. FIG. 1 shows a partially fragmented view of a hose embodiment of the invention. Hose 11 is a multi-layer hose including inner tube 20, reinforcement layer 17, shown comprising spiraled reinforcements 18 and 19, outer tube 16, and outer cover layer 22. According to the invention, outer cover layer is a wrapped polyurethane cover layer. The polyurethane is wrapped onto the outer tube layer, and then wrapped with fabric tape for curing, after which the fabric tape is removed. Both the wrapping of the polyurethane and the fabric tape impart helical thickness variations 24 in the outer cover layer indicative of helically wrapped hose. Outer cover layer 22 is bonded to outer tube 16. The outer tube is preferably a vulcanized elastomer layer to which the wrapped polyurethane film is bonded. The helical seams of the wrapped polyurethane film are fused together to form a continuous layer and bond to the outer tube during vulcanization of the hose. The hose has the distinctive marks of the fabric wrap used in the vulcanization process, namely helical thickness variations 24.

Preferably the polyurethane is a polyether polyurethane with at least one fire retardant additive, preferably an intumescent fire retardant additive. Preferably the polyurethane is an aromatic polyether polyurethane with at least one fire retardant additive, preferably an intumescent fire retardant additive, or an intumescent fire retardant system. The polyurethane is preferably an intumescent, fire-retardant, thermoplastic polyurethane (“TPU”) composition. Preferably the polyurethane composition has no halogens. Preferably the polyurethane has a UL 94 vertical burn test fire rating of V0. The polyurethane should be thermally stable at the vulcanization temperature of the hose, or at least up to 305° F. (152° C.), preferably up to 350° F. (175° C.). By “thermally stable” is meant the polyurethane does not foam or otherwise undergo irreversible chemical changes which might be detrimental to the function, durability, or appearance of the hose. Preferably the polyurethane is thermally stable at that temperature for at least long enough to cure or vulcanize the vulcanizable layers of the hose. For example, typical vulcanization times could be from 20 to 60 minutes. The polyurethane should be able to soften or melt enough to fuse to itself and/or bond to other layers at the vulcanization temperature. The polyurethane may advantageously be thermally stable at temperatures up to its melting point or higher. It is advantageous for steam curing that the polyurethane also be thermally stable in steam environments.

“Polyurethane” means any conventional TPU polymer, chemically speaking, that is known to the art and in the literature as long as the TPU polymer meets the additional qualifications described herein. The TPU polymer is generally prepared by reacting a polyisocyanate with an intermediate such as a hydroxyl terminated polyester, a hydroxyl terminated polyether, and a hydroxyl terminated polycarbonate or mixtures thereof, with one or more chain extenders, all of which are well known to those skilled in the art. Preferably the intermediate is a polyether, resulting in a “polyether” polyurethane. Preferably the polyisocyanate is also an aromatic isocyanate, resulting in an “aromatic,” polyether polyurethane.

Hydroxyl terminated polyether intermediates are polyether polyols derived from a diol or polyol having a total of from 2 to 15 carbon atoms, preferably an alkyl diol or glycol which is reacted with an ether comprising an alkylene oxide having from 2 to 6 carbon atoms, typically ethylene oxide or propylene oxide or mixtures thereof. For example, hydroxyl functional polyether can be produced by first reacting propylene glycol with propylene oxide followed by subsequent reaction with ethylene oxide. Primary hydroxyl groups resulting from ethylene oxide are more reactive than secondary hydroxyl groups and thus are preferred. Useful commercial polyether polyols include poly(ethylene glycol) comprising ethylene oxide reacted with ethylene glycol, polypropylene glycol) comprising propylene oxide reacted with propylene glycol, poly(tetramethyl glycol) comprising water reacted with tetrahydrofuran (PTMG). Polytetramethylene ether glycol (PTMEG) is the preferred polyether intermediate. Polyether polyols further include polyamide adducts of an alkylene oxide and can include, for example, ethylenediamine adduct comprising the reaction product of ethylenediamine and propylene oxide, diethylenetriamine adduct comprising the reaction product of diethylenetriamine with propylene oxide, and similar polyamide type polyether polyols. Copolyethers can also be utilized in the current invention. Typical copolyethers include the reaction product of THF and ethylene oxide or THF and propylene oxide. These are available from various suppliers as a block copolymer or as a random copolymer. The various polyether intermediates generally have a number average molecular weight (Mn), as determined by assay of the terminal functional groups which is an average molecular weight, of from about 500 to about 10,000, desirably from about 500 to about 5,000, and preferably from about 700 to about 3,000.

Suitable extender glycols (i.e., chain extenders) are lower aliphatic or short chain glycols having from about 2 to about 10 carbon atoms and include for instance ethylene glycol, diethylene glycol, propylene glycol, dipropylene glycol, 1,4-butanediol, 1,6-hexanediol, 1,3-butanediol, 1,5-pentanediol, 1,4-cyclohexanedimethanol hydroquinone di(hydroxyethyl)ether, neopentyglycol, and the like, with 1,4-butanediol being preferred.

The desired TPU polymer used in the TPU composition of this invention is generally made from the above-noted intermediates such as a hydroxyl terminated polyesters, polyether, or polycarbonate, preferably polyether, which is further reacted with a polyisocyanate, preferably a diisocyanate, preferably an aromatic diisocyanate, along with extender glycol desirably in a so-called one-shot process or simultaneous co-reaction of polyester, polycarbonate or polyether intermediate, diisocyanate, and extender glycol to produce a high molecular weight linear TPU polymer. The preparation of the TPU polymer is generally well known to the art and to the literature and any suitable method may be used. The weight average molecular weight (Mw) of the TPU polymer is generally about 80,000 to 500,000, and preferably from about 90,000 to about 250,000. The equivalent weight amount of diisocyanate to the total equivalent weight amount of hydroxyl containing components, that is the hydroxyl terminated polyester, polyether, or polycarbonate, and chain extender glycol, is from about 0.95 to about 1.10, desirably from about 0.96 to about 1.02, and preferably from about 0.97 to about 1.005. Suitable diisocyanates include aromatic diisocyanates such as: 4,4′-methylenebis-(phenyl isocyanate) (MDI); m-xylylene diisocyanate (XDI), phenylene-1,4-diisocyanate, naphthalene-1,5-diisocyanate, diphenylmethane-3,3′-dimethoxy-4,4′-diisocyanate and toluene diisocyanate (TDI); as well as aliphatic diisocyanates such as isophorone diisocyanate (IPDI), 1,4-cyclohexyl diisocyanate (CHDI), decane-1,10-diisocyanate, and dicyclohexylmethane-4,4′-diisocyanate. Preferred aromatic polyether polyurethane includes polyurethanes based on aromatic isocyanates (e.g. MDI and TDI) and mostly polyether polyols.

When a higher molecular weight TPU polymer is desired, it can be achieved by using a small amount of a cross linking agent having a functionality greater than 2.0 to induce cross linking. The amount of cross linking agent used is preferably less than 2 mole percent of the total moles of chain extender, and more preferably less than 1 mole percent. An exemplary method to increase the molecular weight in a TPU polymer is to replace less than 1 mole percent of the 1,4-butanediol chain extender with trimethylol propane (TMP).

The method of adding a cross linking agent in the manufacture of the TPU polymer is effective in improving the flame retardancy of a TPU composition when any flame retardant additive is used which will degrade the TPU polymer when the TPU is exposed to melt processing temperatures. A slight cross linking of the TPU polymer increases its molecular weight and allows it to perform better in a fire situation. When using the cross linking agent in the TPU polymer, flame retardant additives such as melamine, melamine phosphate, melamine cyanurate, melamine borate, other melamine derivatives, organic phosphates, organic phosphonates, and other flame retardants known in the art to degrade TPU polymers, the flame retardancy performance in UL-94 or UL-1581 type tests of the TPU composition is improved. Mixtures of the above flame retardants can also be used, such as a mixture of melamine cyanurate together with an organic phosphate or organic phosphonate to create a flame retarded TPU composition having improved performance in UL-94 or UL-1581 type test by using a cross linking agent. Additives to improve adhesion to rubber may be used advantageously provided the flame resistance is not degraded thereby. One option for improving adhesion of rubber to TPU is using hexamethylene melamine.

The cross linking is accomplished by adding a cross linking agent having a functionality greater than 2.0 together with the hydroxyl terminated intermediate, the isocyanate compound, and chain extender in the reaction mixture to manufacture the TPU polymer. The amount of cross linking agent used in the reaction mixture to make the TPU polymer will depend on the desired molecular weight and the effectiveness of the particular cross linking agent used. Usually, less than 2.0 mole percent, and preferably less than 1.0 mole percent, based on the total moles of chain extender used in making the TPU polymer are used. Levels of cross linking agent less than 0.05 mole percent of the total moles of chain extender would not give a meaningful improvement in flame performance. Levels of cross linking agent greater than 2.0 mole percent, based on the total moles of chain extender would be difficult to melt process. Therefore, the level of cross linking agent used may be from about 0.05 mole percent to about 2.0 mole percent based on the total moles of chain extender.

The cross linking agents can be any monomeric or oligomeric materials which have a functionality of greater than 2.0 and have the ability to cross link the TPU polymer. Such materials are well known in the art of thermoset polyurethanes. They include trimethylol propane (TMP), pentaerythritol, amines, 3-isocyanato-methyl-3,5,5-trimethylcyclo-hexyl isocyanate (IPDI), and the like. Trimethylol propane has been found to particularly be a desirable cross linking agent.

Fire retardant additives are additives to the polyurethane which improve the resistance of the polyurethane to ignition and/or reduce the rate of burning or rate of heat released during burning and/or perform other related desirable functions such as reducing smoke generation, reducing toxicity of decomposition products, or improving the integrity of the article in a fire. As mentioned above, various melamine and/or phosphate derivative flame retardant additives may be used, alone or in suitable combinations. Preferably, no halogen-based additives are used, for environmental reasons.

Intumescent fire retardant (or flame retardant) additives are those that cause the polyurethane to foam and harden when exposed to extreme heat or flame, resulting in a insulating barrier of char which can delay or prevent the destruction of the inner hose layers in a fire environment. The phenomenon of intumescent fire retardance is based on the expansion of the reagents into a charred carbonaceous foam on heating. The charred foam is an insulator of low combustibility which at the same time retards the release of flammable gases from the heated mass and the diffusion of oxygen toward the polymer. Intumescent fire retardant compounds are thus characterized by their foaming and char-forming properties.

Generally intumescent fire retardant compounds are based on three main components: a spumifier or foaming agent, which is a source of gases or vapors in order to form the foam; a carbonifier or char former, which is a source of pyrolytic carbon in order to form the char, and a catalyst, which serves to induce intumescence. Carbonifier components may be represented by polyhydroxy compounds such as sugars, polyvinyl alcohol, pentaerythritol, etc. These components provide the carbon for char and may also contribute to the evolution of gases. Spumific components are selected from nitrogenous compounds such as urea, guanidine, dicyandiamide, etc. In some cases they induce also contribute to char formation or resinification during the thermolytic process. The compounds may also be utilized in a polymeric form. The catalyst may be generally an acidic material, or one which generates an acid component on pyrolysis. Commonly used substances in this category are phosphoric acid or polyphosphoric acid and typical examples of compounds which generate an acidic component, are ammonium phosphates, melamine phosphate, etc. However, some fire retardant components can function in more than one way. For example, triethanolamine can serve either as a spumifier or a carbonifier or can accomplish both functions at the same time. Thus, triethanolamine in combination with a catalyst such as P₂O₅ or a suitable P₂O₅-precursor will produce an effective intumescent fire retardant when mixed with the polymer, as described for example in U.S. Pat. No. 4,404,297. The P₂O₅ catalyst can be incorporated either as a powder of P₂O₅ or preferably from the handling point of view in the form of phosphoric acid or its salts which by thermal decomposition will produce the P₂O₅. Examples of P₂O₅-precursors are: ammonium phosphates, polyphosphoric acids or their amine or ammonium salts, organic phosphates, pyrophosphoric acid or its salts etc. It may be desirable to add to the fire retardant system according to the present invention, other compounds known to be useful in fire retardant compositions such as melamine, melamine derivatives, pentaerythritol, aluminum sulfate, borax, antimony salts, etc.

Various intumescent fire retardant systems for polyurethane may be utilized in the present invention. It is important for the present invention that the polyurethane composition be stable at processing temperatures experienced during hose manufacture, such as temperatures in the range 300-350° F. U.S. Pat. No. 6,777,466 teaches a suitable intumescent fire retardant system for polyurethane based on melamine cyanurate as the single fire retardant additive, the entire contents of which are hereby incorporated herein by reference. The TPU compositions described therein were stable at processing temperatures up to 360° F. (180° C.).

A suitable TPU material is the halogen-free, flame retardant polyether-based TPU sold under the trademark ESTANE® ZHF95AT3 by Lubrizol Advanced Materials, Inc., which has a limiting oxygen index (LOI) of 38% when tested according to ASTM D2863, a melting point of 350° F. (175° C.) when tested by DSC (Differential Scanning Calorimetry), can be processed without foaming at temperatures up to at least 360° F. (180° C.), and has a hardness of 52 Shore D (96 Shore A) according to ASTM D2240. Other ESTANE grades with high hardness greater than about 90 Shore A and softening points greater than about 300° F. (149° C.) may also be suitable. Lower hardness (and/or higher ultimate elongation) might be helpful to reduce the chance of TPU cracking, for example less than about 90 Shore A.

Other TPU materials believed to be suitable for the present invention include: the halogen-free polyether TPU materials sold under the trademark ELASTOLLAN® by BASF, particularly those grades with high hardness greater than 90 Shore A; those specialty flame retarded aromatic polyether TPU films sold under the trademark DUREFLEX® by Bayer Material Science Company, particularly those grades with high hardness greater than about 90 Shore A and softening points greater than about 300° F. (149° C.).

The inner tube layer 20 may be provided as extruded, molded, or otherwise formed of a plastic, elastomeric, or other polymeric resin which may be a thermoplastic or a thermoset. Suitable thermoplastic materials, along with copolymers and blends, mixtures, alloys, or other combinations thereof, include polyesters, polyvinyl chlorides, polyimides, polyurethanes, poly(ether ether ketone), polyetherimides, polybutylene and polyethylene terephthalates, polysulfones, polyacrylics, polymethylacrylates, polymethylmethacrylates, polycarbonates, poly(ester and ether urethanes), liquid crystal polymers (LCP), acetal homo and copolymers, polyolefins such as high density or molecular weight polyethylene and polyamides such as Nylon 11 and 12, and fluoropolymers, which may be specifically selected for high or low temperature resistance, surface characteristics such as coefficient of friction, physical or mechanical properties such as flexural modulus, or, in the case of fluid contact or transfer, chemical compatibility with the fluid being handled. As used herein, “chemical resistance” should be understood to mean the ability to resist swelling, crazing, stress cracking, corrosion, or otherwise to withstand attack from mild acidic or alkaline solutions, phosphate-ester solutions, and alcohols and other organic solvents and hydrocarbons, as well as inorganic solvents such as water or brine. As mentioned the material forming the inner tube 20 may be a homo or copolymer, or a combination thereof such as a blend of one or more homopolymers, one or more copolymers, or one or more homopolymers and one or more copolymers. Such materials each additionally may be admixed with other resins, which may be thermoplastic or thermosetting, such as to form an alloy, blend, mixture, or other combination, or a copolymer thereof.

Alternatively, inner tube 20 may be formed of a synthetic rubber such as a chlorosulfonated polyethylene, polybutadiene, butyl, chloroprene, nitrile, polyisoprene, or buna-N, a copolymer rubber such as ethylene-propylene (EPR), ethylene-propylene-diene monomer (EPDM), nitrile-butadiene (NBR), hydrogenated nitrile-butadiene (HNBR) or styrene-butadiene (SBR), or a blend such as ethylene or propylene-EPDM, EPR, or NBR, or a copolymer or blend of any of the foregoing. The term “synthetic rubber” also should be understood to encompass both curable or thermoset materials as well as materials which alternatively may be classified broadly as thermoplastic elastomers such as polyurethanes, silicones, fluorosilicones, styrene-isoprene-styrene (SIS), and styrene-butadiene-styrene (SBS), as well as other polymers which exhibit rubber-like properties such as plasticized nylons, polyesters, ethylene vinyl acetates, and polyvinyl chlorides.

The material forming inner tube 20 and outer tube 16 may be compounded with one or more other fillers, and/or with modifiers or other additives. Such additives, which may be functional or inert, may be provided to be in liquid, powder, particulate, flake, fiber, or other form, and may include other electrically-conductive fillers, microwave-attenuating fillers, thermally-conductive fillers, lubricants such as molybdenum disulfide, wetting agents, surfactants, adhesion promoters, stabilizers, antioxidants, dispersants, pigments, dyes, and other colorants, colorings, or opacifying agents such as for coloring-coding of the tubing, luminescents, light reflectants, anti-static agents, coupling agents such as titanates, chain extending oils, tackifiers, flow modifiers, blowing agents, foaming or anti-foaming agents, reinforcements such as glass, carbon, or textile fibers, silanes, peroxides, film-reinforcing polymers and other agents, emulsifiers, thickeners, and/or flame retardants and other fillers such as chlorinated oils, aluminum trihydrate, antimony trioxide, metal oxides and salts, intercalated graphite particles, phosphate esters, decabromodiphenyl oxide, borates, siloxanes, phosphates, halogenated compounds, glass, silica, which may be fumed or crystalline, silicates, mica, ceramics, and glass or polymeric microspheres. Typically, the additives are blended or otherwise admixed with the base material, and may comprise between about 0.05% and 80% or more by total volume of the formulation.

Inner tube 20 also may be provided as having a multi-layer, i.e., two or more layer, laminate construction comprising two or more of the aforementioned materials. The wall thicknesses of each of the layers forming the inner tube 20, may be of any thickness, both absolute and relative to the thickness of the other layers. The overall wall thickness of inner tube 20 may be of any thickness, both absolute and relative to the thickness of the other layers of the hose Inner tube may also have a desired compression set and/or modulus, for example to withstand crimping forces occurring in use. Inner tube 20 and outer tube 16 are preferably sulfur cured to promote adhesion to brass coated steel wire.

With continuing reference to the illustrative construction of hose 11 depicted in FIG. 1, one or more reinforcement layers 17 may be provided as knitted, braided, woven, spiral, i.e., helically, or otherwise wound, and/or wrapped or otherwise formed to surround the inner tube 20. Each of the reinforcement layers 17 may be formed of one or more filaments, which may be monofilaments, continuous multi-filament, i.e., yarn, stranded, cord, roving, thread, braid, tape, or ply, or short “staple” strands, of one or more fiber materials. The fiber material, which may be the same or different in each of the reinforcement layers which are provided, and which may be a blend, alloy, or other combination of two or more different materials in each layer, may be a natural or synthetic polymeric material such as a nylon, cotton, polyester, polyamide, aramid, polyolefin, polyvinyl alcohol (PVA), polyvinyl acetate, rayon or polyphenylene benzobisoxazole (PBO), or a blend or other combination thereof, or, particularly, a metal wire such as a steel, which may be galvanized or stainless or otherwise corrosion resistant, aluminum, nickel, copper, brass, or zinc or zinc-plated, or a blend, alloy, or other combination thereof. Preferably, the metal wire is steel with a brass-coating. In FIG. 1, reinforcement layer 17 is depicted as two layers 18 and 19 of spiral wound wire or cord, layer 18 wound in the opposite direction as layer 19. A preferred embodiment for high pressure hydraulic applications has four layers of spiraled steel wire or stainless steel wire, in balanced pairs (i.e., one layer spiraled in each direction at equal and opposite angles as in layers 18 and 19 of FIG. 1).

The outer tube layer 16 may be provided as was the inner tube 20, of one layer or of a laminate construction or one or more materials as described above for the inner tube, namely thermoplastics, synthetic rubbers, and the like. The selection considerations for the material of outer tube 16 may however be different from those for inner tube 20. Outer tube 16 may generally be selected for toughness, adhesion to reinforcement, adhesion to TPU, resistance to environmental conditions, and the like.

Other layers of elastomers, plastics and/or textiles may be present in the hose, such as breaker layers, adhesive layers, barrier layers, reinforcement layers, or the like.

Preferably the outer tube layer 16 and polyurethane outer cover layer 22 are compatible in the sense that, when heated to simultaneously fuse the TPU cover and cure the outer tube layer, a strong bond between the two materials readily develops. This contributes to the resulting hose advantageously exhibiting excellent durability and resistance to delamination in particular. We found that chloroprene rubber adhered well with or without the use of a maleic anhydride adhesion promoter for adhesion to an aromatic polyester polyurethane. A maleated polybutadiene adhesion system in polychloroprene gave good adhesion to polyether polyurethane. We also found that adhesion to an aromatic polyether polyurethane was improved when an NBR outer tube incorporated an HRH (hexamethylene-tetramine, resorcinol, and hydrated silica) adhesion system. Thus, any suitable adhesion-promoting system may be incorporated into the outer tube layer 16 to promote adhesion to the cover layer 22.

The invention is also directed to a hose assembly or system having an embodiment of the inventive hose and one or more couplings. The coupling may be of the hydraulically crimped type or swaged type. The coupling may be applied to an end portion of the hose where the outer polyurethane layer has been removed. The coupling area may include some fire resistant sleeve, insulating tape, or the like, for example to compensate for the removed polyurethane. FIG. 3 illustrates an embodiment of hose assembly 31 with hose 11 of FIG. 1 having coupling 32 mounted on the end thereof. In FIG. 3, hose 11 is shown cut away with inner tube 20, reinforcement layer 17, outer tube 16, and fire resistant outer cover layer 22. Coupling 32 has stem 34 which may have optional male pipe thread 36 or any other suitable connector style known in the art, hex section 38, and nipple 40 adapted for insertion into the hose end. Coupling 32 latch 42 for engaging with ferrule 46. In use, nipple 40 is inserted into the hose end, ferrule 46 is place over the hose end and swaged or crimped to engage with latch 42 and hold the hose tightly. The fire resistant cover layer 22 may be removed from the hose end for the approximate length of ferrule 46. This may be advantageous since layer 22 is of TPU which may creep or flow under the pressure exerted by ferrule 46. For better fire resistance in the coupling area, the ferrule 46 and hose end may be wrapped or covered with fire resistant tape 49, which may in turn be covered by over ferrule 48. Over ferrule 48 may then be hydraulically crimped or swaged, engaging with over ferrule latch 44 and with hose 11. As shown in FIG. 3, over ferrule 48 may be twice crimped, so that the portion covering ferrule 46 and fire resistant tape 49 has a first diameter, and the portion contacting hose 11 at 47 in FIG. 3 may have a second diameter, in this case smaller that the first diameter. It should be understood that this coupling and assembly is meant to be exemplary, and that many coupling designs are known in the art which may be used in the practice of the present invention.

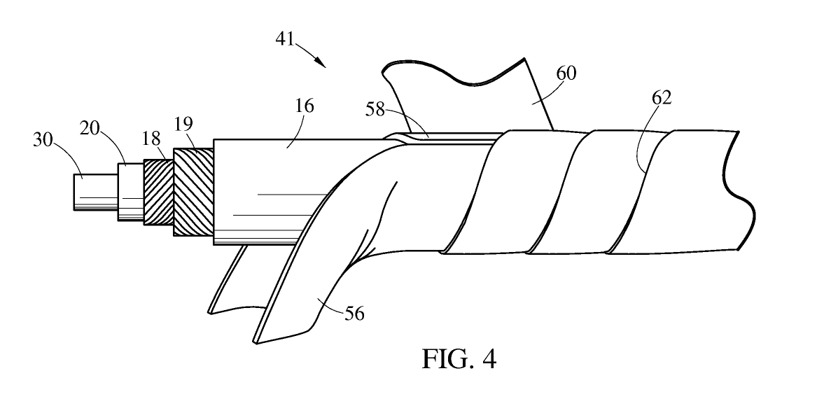

In another embodiment of the invention, the polyurethane outer layer may be wrapped longitudinally like a cigarette. In this embodiment, the polyurethane strip may advantageously have a width approximately equal to the hose circumference and be butt joined when wrapped. Alternately, the polyurethane strip may advantageously have a width bigger than the hose circumference and be lapped when wrapped. The resulting hose may thus have a longitudinal fused polyurethane seam instead of a helical seam, which may be preferred in some applications. The outer surface of the hose may still have a visible helical pattern from the wrapping tape used to vulcanize the hose. A hose according to this embodiment is illustrated in FIG. 4. In FIG. 4, hose 41 is shown in the process of being built up on mandrel 30. Inner tube 20 is wrapped with spiral reinforcing cord layers 18 and 19, which are in turn covered with outer tube layer 16. Fire resistant outer cover layer 56 is being wrapped longitudinally, with seam 58 resulting. Wrapping tape 60 is shown being spirally wound 22 onto the completed hose build with helix 62 which will result in a helical pattern on the surface of the finished hose after vulcanization.

In an exemplary construction the elastomer layer may be a polychloroprene or NBR composition. The polyurethane may be an aromatic polyether polyurethane. Also the compositions may contain additives such as UV stabilizers, pigments, antistatic agents etc. In selecting such additives, one should understand that the additives should not have a negative effect with respect to char formation and with respect to flame retardancy.

The invention is particularly suited to a high pressure hydraulic hose having a cover layer of fire retardant polyurethane wrapped onto it in order to impart the flame resistance needed for offshore oilfield applications such as API Specification 16D, “Specification for Control Systems for Drilling Well Control Equipment and Control Systems for Diverter Equipment,” (2d Ed., July 2004). API 16D §10.1.2.1 calls for hose capable of containing the hose working pressure in a flame temperature of 1300° F. (700° C.) for a 5-minute period. This test is similar to “Lloyd's Register Fire Tests for Flexible Hoses on Offshore Installations,” OD/1000/499 (rev. 1, 18 Oct. 1995). These tests apply to kill, choke and jumper hoses, and hydraulic control hoses serving well completion units and blow out preventers. Embodiments of the inventive hose assembly pass a fire test requiring no loss of pressure for five minutes in a gas- or oil-fired furnace at a temperature between 700 and 750° C. under the design maximum working pressure of the hose according to the procedure of Lloyd's Fire Test OD/1000/499. Embodiments of the hose are thus particularly suited for offshore oil drilling applications such as those that must meet the API 16D specification and/or Lloyd's Fire Test OD/1000/499. Embodiments of the inventive hose or hose assembly may also find application in various other fields, including for example, hydraulic hose, industrial hose, transfer hose for fuel or other fluids, marine hose, other oil field applications, and the like. The maximum working pressure of the hose may be, for example, 5000 psi or 6000 psi.

The invention is also directed to a method of making a flame resistant hose including the steps of forming one or more inner layers and outer tube layers including at least one vulcanizable rubber layer, applying as an outer cover layer a wrapped strip of fire retardant polyurethane to form a hose build, applying a fabric wrap and curing the wrapped hose build at a suitable temperature and for a suitable time period. Curing this way vulcanizes the rubber layer, fuses the helically wrapped polyurethane to itself, and bonds the polyurethane to the outer tube layer. The fabric wrap, which may be nylon wrap, may then be easily removed. The outer cover layer may be helically wrapped or longitudinally wrapped. The wrapping may result in thickness variations visible at the interface between the outer tube and the outer cover layer. The wrapping tape used for vulcanization may reduce or hide the wrapping pattern of the polyurethane on the outer surface of the hose. Thus, there may be a helical or longitudinal pattern in the wrapped polyurethane which is more visible within the hose, and the outer wrapping pattern may be predominantly from the wrapping tape, which may be of a very different helical angle from the polyurethane wrap angle.

It should be understood that the invention may also involve a wrapped flame retardant outer tube layer that is not urethane but meets the softening and fusing requirement as well as the adhesion and flame resistance requirements and survives the vulcanization conditions without foaming or degrading.

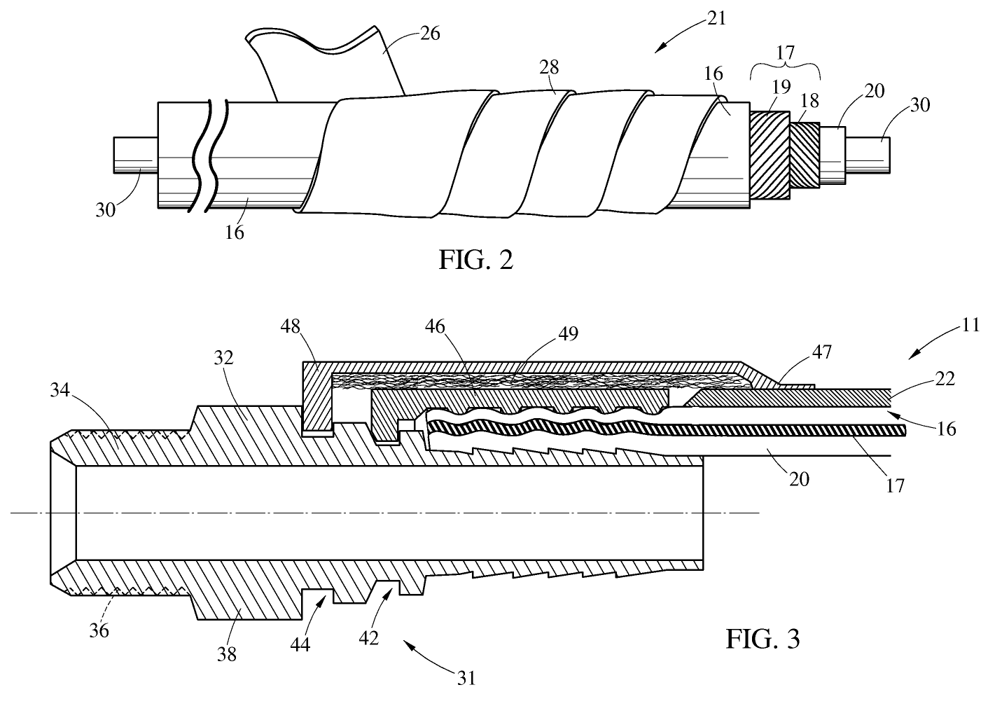

FIG. 2 is illustrative of an embodiment of the inventive method. In FIG. 2, the hose is built on mandrel 30. Inner tube 20 is provided first, followed by reinforcement layer 17, shown again as two helically wrapped layers 18 and 19, followed by outer tube 16. These layers may be of any desired construction and materials as described previously. They may be applied or provided by any suitable process, such as extruding, wrapping, spiraling, and the like. The hose build 21 is completed by wrapping polyurethane strip 26 around outer tube 16. The polyurethane is as described above, i.e., fire resistant, preferably intumescent aromatic polyether TPU with a high hardness and stable to at least 300 or 305° F., preferably to 350 or 360° F. The wrapping of the polyurethane may be a single layer or include an overlap as shown at lap 28 in FIG. 2, for example, to obtain the total desired thickness in the outermost cover layer. Resulting hose build 21 is then wrapped with a wrapping tape, i.e., a cure tape, nylon wrapping cloth, or the like and vulcanized under pressure and at a suitable temperature for a suitable time, to effect cure of the vulcanizable rubber component(s) in the hose and to fuse the polyurethane wrap into a continuous outer cover layer, and finally, to also effect a secure bond between the outer cover layer and the outer tube layer. After vulcanization the wrapping tape may be removed. It has been found that for this purpose nylon fabric tape works very well, providing the desired pressure for fusing and bonding, and being easily removable from the cured hose. Any suitable wrapping tape material may be used. Wrapping tape may be for example, thermoplastic film, woven or nonwoven fabric, rubberized fabric, or the like. Preferably the wrapping tape exerts a retraction force when heated to vulcanization temperatures, thus pressurizing the hose. Typical curing temperatures may be from about 300 to about 350° F., or from about 150 to about 175° C., which may be provided for example by saturated steam at about 50 psi to about 120 psi.

As discussed previously, the polyurethane film 26 used for the outer cover preferably has a softening temperature or a melting temperature that is below or near the desired cure temperature. The polyurethane preferably has fire retardant additives that do not react at the desired cure temperature. The polyurethane is preferably non-foaming at the desired cure temperature. It is also advantageous for the use of steam cure that the polyurethane is non-foaming in steam at the desired cure temperature.

Embodiments of the inventive method provide reduced process steps over the prior art, in particular the polyurethane wrapped layer may be applied to an uncured hose build and the entire assembly cured in one cure operation. In contrast, prior art hoses were first cured without an outer cover layer, then a fire-resistant outer cover was applied in a separate, often tedious, operation. For example, in one prior art example, the hose was wrapped with fire resistant inorganic fiber such as glass tape, then sheathed in a helical metal conduit. It was a surprise that such a construction could be replaced by a thermoplastic polyurethane cover layer, which was expected to melt and drip off in the requisite Lloyd's fire test, as will be discussed below. In another example, a hose from Hydrasun uses a polyurethane layer extruded over a previously-vulcanized hose. Such an approach would not be expected to exhibit as robust adhesion between hose and polyurethane as the inventive co-vulcanization approach. Nevertheless, in yet another embodiment of the invention, it has been found that a previously vulcanized hose, can be wrapped with polyurethane film, helically or longitudinally, followed by wrapping in cure tape and vulcanization to fuse the polyurethane with adequate bonding to the vulcanized elastomer layer of the hose.

In a preferred embodiment, suitable for use as hydraulic hose at extremely high working pressures, the inner tube may be of a nitrile rubber (NBR) composition, the reinforcement may be a number (preferably an even number, for example, four) of spiraled steel wire layers, and the outer tube may be of a polychloroprene rubber (CR) composition. Such a hose embodiment is found to pass the Lloyd's Fire Test OD/1000/499.

An example hose was constructed for testing purposes. The inner tube was of a vulcanizable nitrile rubber (NBR) composition, the reinforcement was four layers of spiraled brass-coated steel wire in two balanced pairs, and the outer tube was of a vulcanizable polychloroprene rubber (CR) composition. The polyurethane strip used to wrap the hose build was an intumescent, aromatic polyether TPU with a strip thickness of 0.045 inches (1.14 mm) and a width of 4 inches (102 mm), and the material composition was Estane® ZHF95AT3, sold under that trademark by Lubrizol Advanced Materials, Inc. The TPU strip overlapped itself about one-half, as was illustrated in FIG. 2. A nylon wrap was used for the curing step, which was carried out in a steam vulcanizer at steam pressure of about 59 psi, temperature of 305° F. (152° C.), for 60 minutes. Another similar hose used to pass the 16D and Lloyds 1000/499 fire testing had an inside diameter (ID) of 1.00″, outside diameter (OD) of 1.65″, and used two plies of 0.030″ thick TPU.

The nylon wrap was removed with no sticking problems. There was no foaming of the TPU during the cure step. In addition to having adequate adhesion to the CR layer, the TPU had fused into a continuous layer about 0.045-0.075 inches thick. The TPU outermost cover layer showed the characteristic helical pattern of a wrapped hose.

The hose was pressurized with water to the maximum working pressure, 6000 psi, and placed in a 700° C. furnace. When the hose temperature reached the furnace temperature (2.5 minutes from RT to 1350 deg F.) a flame was applied for five minutes. The TPU exhibited minimal dripping, and formed a protective char. The CR outer tube was somewhat damaged by the flame. The fire test was considered “passed” as there was no additional volume of fluid (water) needed to be pumped into the hose/coupling system.

The inventive hose also passed an adhesion test. Adhesion is important to prevent abrasion loss, dripping off in the presence of extreme heat and to keep TPU from cracking or delaminating from the outer tube layer. Abrasion testing showed improvement over the use of the standard chloroprene outer tube layer. With an HRH system in the elastomer layer, the polyurethane layer could not be peeled off after a single vulcanization process. With a maleated polybutadiene adhesion promoter in a pre-vulcanized process, the polyurethane exhibited adequate adhesion with significant tearing of the urethane during a peel test.

A polyester TPU may be used for some applications since it would have good to a chloroprene outer tube and good chemical resistance. But polyester TPU may be prone to foam during steam vulcanization not as good resistance to under water environments as polyether TPU.

The hose and methods of the present invention thus provide a number of advantages over other approaches in the art. The inventive wrapping method involves fewer steps than prior extruded-cover constructions. The application of the urethane cover is less labor intensive than the steel sheath and flame resistant sleeve of other hose constructions. On common wrapping equipment, adjacent edges of the strip may be overlapped to increase or vary the thickness of the polyurethane layer over the thickness of the strip itself Thus, there is much process flexibility in embodiments of the invention. The flame resistance of the hose is excellent. Adhesion of TPU to cured elastomer layers is excellent. The cover tube, 16, may have adhesion promoters of maleic anhydride, maleated polymers, melamines, resorcinol, and the like to improve bonding to TPU. Also the cover tube, 16, may have a sulfur cure system to promote bonding to brass-plated steel wire. Release of nylon wrapping tape may be excellent, even without use of a lubricant. The polyurethane provides a non-halogen system. The polyether polyurethane may be capable of submersible application. The urethane is thermoplastic in nature and as such, has a 6-12 month shelf life since there is no cure system to initiate. This is generally an improvement over an elastomeric flame resistant cover that requires vulcanization.

The hose may be built according to various methods. In one embodiment, the method of making the inventive hose includes the following steps. An inner tube is formed of predetermined length. The inner tube may be formed, for example, by extruding a tube or layer of plastic or elastomeric composition. The inner tube may be formed on a mandrel. Then a reinforcement layer is applied onto the inner tube. The reinforcement layer may be braided, spiraled, knit, wrapped, or woven filaments, wires, yarns, or fabrics. The reinforcement layer may be made up of a number of layers of reinforcing textiles or materials, and there may be layers of elastomer or plastic materials there between. Then a first cover layer is applied onto the reinforced inner tube. The first cover may be formed, for example, by extruding or wrapping a tube or layer of plastic or elastomeric composition onto the reinforced inner tube, which may all be done on a mandrel. At least one of the inner tube and the first cover layer may be of a curable elastomeric composition. Both may be of the same composition. Then a strip of intumescent, thermoplastic polyurethane is helically or longitudinally wrapped around the length of the covered, reinforced tube, with adjacent helical or longitudinal edges of the strip either abutting or lapping. At this stage the plied up layers will be called a “PU-wrapped hose build.” All that remains is to heat the PU-wrapped hose build to fuse the helical seam of the helically wrapped polyurethane. Preferably the heating process simultaneously cures any of the elastomeric compositions which are curable and which are used in any of the layers of the hose build. Before heating the hose to fuse the polyurethane, the hose build is preferably wrapped in a wrapping tape, which may be for example nylon cloth. Then the wrapped hose build is heated to sufficient temperature and for a time sufficient to fuse the polyurethane and cure the elastomer compositions involved. Curing the wrapped hose build may be at a temperature above the softening point of the polyurethane for a time period sufficient to cure said elastomeric composition. After curing, the wrapping tape is removed from the cured hose, and the hose is removed from the mandrel if a mandrel was used.

In another embodiment of the method, a hose build comprising the plied up layers of the inner tube, reinforcement if any, and the outer tube may be vulcanized before applying the PU wrapping.

Although the present invention and its advantages have been described in detail, it should be understood that various changes, substitutions, and alterations can be made herein without departing from the spirit and scope of the invention as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps. The invention disclosed herein may suitably be practiced in the absence of any element that is not specifically disclosed herein.

What is claimed is:

1. A multi-layer flexible hose comprising: at least one vulcanized elastomer layer and an outermost cover layer; with said outermost cover layer comprising a thermoplastic polyurethane strip that is wrapped and thermally fused to form a continuous layer.

2. The hose of claim 1 wherein said polyurethane is an aromatic polyether polyurethane with at least one, flame retardant additive and said polyurethane is thermally stable at temperatures up to the vulcanization temperature of said hose.

3. The hose of claim 2 wherein said polyurethane is thermally stable at temperatures up to at least 152° C.

4. The hose of claim 2 wherein said polyurethane is thermally stable at temperatures up to the melting point of the polyurethane.

5. The hose of claim 2 wherein said additive is an intumescent flame retardant additive.

6. The hose of claim 3 wherein said vulcanized elastomer layer comprises an adhesion promoter.

7. The hose of claim 1 wherein said outermost cover layer is in contact with and is bonded to said at least one vulcanized elastomer layer.

8. The hose of claim 1 comprising an inner tube, a reinforcement layer, and a first cover layer, wherein said first cover layer comprises said vulcanized elastomer layer and said outermost cover layer is in contact with and bonded to said first cover layer.

9. The hose of claim 3 wherein said vulcanized elastomer layer comprises polychloroprene rubber.

10. The hose of claim 3 wherein said vulcanized elastomer layer comprises nitrile-butadiene rubber.

11. The hose of claim 1 wherein said hose has an outer surface which bears a helical pattern from a wrapping tape.

12. The hose of claim 11 wherein said polyurethane strip is wrapped helically.

13. The hose of claim 11 wherein said polyurethane strip is wrapped longitudinally.

14. The hose of claim 1 wherein the outermost cover layer has a seam.

15. The hose of claim 2 having a fire test rating of at least five minutes at at least 700° C. at the design maximum working pressure according to the test requirements of API 16D or of Lloyd's Register Fire Tests for Flexible Hoses on Offshore Installations OD/1000/499 rev. 1.

16. A method of making a multi-layer hose comprising:
i) providing a hose build of predetermined length and comprising at least one layer comprising a curable elastomeric composition;
ii) wrapping a strip of thermoplastic polyurethane comprising an intumescent fire retardant onto said hose build to form a PU-wrapped hose build;
iii) wrapping said PU-wrapped hose build with a wrapping tape;
iv) curing said PU-wrapped hose build in said wrapping tape at a sufficient temperature and time period sufficient to cure said elastomeric composition and to fuse said strip of thermoplastic polyurethane to itself and to bond said thermoplastic polyurethane to said hose build without activating said intumescent fire retardant; and
v) removing said wrapping tape from the cured hose.

17. The method of claim 16 wherein said wrapping of said polyurethane strip is helical with adjacent edges of the strip overlapping, to increase the thickness of the polyurethane layer over the thickness of the strip.

18. The method of claim 16 wherein said wrapping of said polyurethane strip is longitudinal with respect to said hose build.

19. The method of claim 16 wherein said curing is at a temperature above the softening point of said polyurethane.

20. The method of claim 16 wherein said hose build comprises an inner tube, a reinforcing layer and an outer cover.

21. The method of claim 16 wherein said curable elastomer composition comprises polychloroprene rubber and an adhesion promoter.

22. The method of claim 16 wherein said curable elastomer composition comprises nitrile-butadiene rubber and an adhesion promoter.

23. The method of claim 16 further comprising applying a reinforcement layer outer to said inner tube.

24. The method of claim 16 wherein said hose build is not vulcanized before said wrapping steps.

25. The method of claim 16 wherein said hose build is vulcanized to cure said elastomer composition before said wrapping steps.
